(19) United States
(12) Patent Application Publication
(10) Pub. No.: US 2010/0199590 A1
(43) Pub. Date: Aug. 12, 2010

(54) Aircraft Cargo Pallet and Method of Manufacture

(75) Inventor: Robert P. Newling, Kingsley, MI (US)

Correspondence Address: BARNES & THORNBURG LLP, P.O. BOX 2786, CHICAGO, IL, 60690-2786, US

(73) Assignee: AAR CORP., Wood Dale, IL (US)

(21) Appl. No.: 12/694,601

(22) Filed: Jan. 27, 2010

Related U.S. Application Data
(60) Provisional application No. 61/150,601, filed on Feb. 6, 2009.

(51) Int. Cl. E04C 2/38; B23P 11/00; B23K 20/12; B29C 65/48; B29C 65/06; B65D 19/38

(52) U.S. Cl. 52/588.1; 29/428; 228/2.1; 156/60; 156/73.5; 108/50.11

(57) ABSTRACT

A panel for an aircraft cargo pallet and other structures including a bottom skin member, a spaced apart top skin member, and core located between the bottom skin member and the top skin member. The core includes a plurality of spaced apart and parallel ribs coupled along their top edges to the top skin member and along their bottom edges to the bottom skin member.

### RELATED PATENT APPLICATIONS

This application claims the benefit of U.S. Provisional Application No. 61/150,601, filed Feb. 6, 2009.

### BACKGROUND

The present disclosure is directed to a panel for aircraft cargo pallets and other structures such as shelters and containers, and the method of making the panel. More particularly, the present disclosure relates to a panel having a top skin member, a bottom skin member and a core disposed between the top and bottom skin members. The core includes a plurality of spaced apart and parallel ribs coupled to the top and bottom skin members.

### BRIEF DESCRIPTION OF THE DRAWING FIGURES

FIG. 1 is a top plan view of an aircraft cargo pallet including the panel of the present disclosure having a plurality of spaced apart and generally parallel ribs extending diagonally with respect to the longitudinal axis of the panel, shown with the top skin member of the panel removed for purposes of illustration;

FIG. 2 is a side elevational view of the aircraft cargo pallet of FIG. 1;

FIG. 3 is an enlarged partial top view of the aircraft cargo pallet taken along line 3 of FIG. 1, with the top skin member removed from the panel for purposes of illustration;

FIG. 4 is a cross sectional view taken along line 4-4 of FIG. 3, but showing the top skin member in place;

FIG. 5 is a cross sectional view taken along line 5-5 of FIG. 3, but showing the top skin member in place;

FIG. 6 is a cross sectional view taken along line 6-6 of FIG. 1, but showing the top skin member in place;

FIG. 7 is a side elevational view of a rib of the panel;

FIG. 8 is a top plan view of another embodiment of the aircraft cargo pallet including a panel having a plurality of spaced apart and generally parallel ribs extending in a direction parallel to the longitudinal axis of the panel, shown with the top skin member removed for purposes of illustration;

FIG. 9 is a side elevational view of the pallet of FIG. 8;

FIG. 10 is an enlarged partial top view of the pallet taken along line 10 of FIG. 8, shown with the top skin member removed for purposes of illustration;

FIG. 11 is a cross sectional view taken along line 11-11 of FIG. 10, but showing the top skin member in place;

FIG. 12 is a cross sectional view taken along line 12-12 of FIG. 10, but showing the top skin member in place;

FIG. 13 is a cross sectional view taken along line 13-13 of FIG. 8, but showing the top skin member in place;

FIG. 14 is a top plan view of a further embodiment of the aircraft cargo pallet including a panel having generally parallel and spaced apart longitudinal ribs and generally parallel and spaced apart transverse ribs in a rectangular grid, shown with the top skin member removed for purposes of illustration;

FIG. 15 is a side elevational view of the pallet of FIG. 14;

FIG. 16 is an enlarged partial top view of the pallet taken along line 16 of FIG. 14, with the top skin member removed for purposes of illustration;

FIG. 17 is a cross sectional view taken along line 17-17 of FIG. 16, but showing the top skin member in place;

FIG. 18 is a cross sectional view taken along line 18-18 of FIG. 16, but showing the top skin member in place;

FIG. 19 is a partial side elevational view of a top rib;

FIG. 20 is a partial side elevational view of a bottom rib;

FIG. 21 is a top plan view of an alternate embodiment of a panel having a plurality of spaced apart and generally linear transverse struts and a plurality of parallel and spaced apart ribs extending transversely between adjacent struts, shown with the top skin member removed for purposes of illustration;

FIG. 22 is an enlarged partial top plan view of the panel of FIG. 21 taken along line 22, with the top skin member removed for purposes of illustration;

FIG. 23 is a cross sectional view taken along line 23-23 of FIG. 22, but showing the top skin member in place;

FIG. 24 is a cross sectional view taken along line 24-24 of FIG. 22, but showing the top skin member in place;

FIG. 25 is a cross sectional view taken along line 25-25 of FIG. 21, but showing the top skin member in place;

FIG. 26 is a cross sectional view taken along line 26-26 of FIG. 21 and additionally showing a thermal barrier between a strut and the bottom skin, and showing the top skin member in place;

FIG. 27 is a cross sectional view taken along line 27-27 of FIG. 21, but showing the top skin member in place;

FIG. 28 is top plan view of a further embodiment of a panel having a plurality of spaced apart and generally parallel transverse struts with a rectangular grid formed by a plurality of longitudinal ribs and a plurality of transverse ribs located between adjacent struts, and shown with the top skin member removed for purposes of illustration;

FIG. 29 is an enlarged partial top view of the panel of FIG. 28 taken along line 29 of FIG. 28, shown with the top skin member removed for purposes of illustration;

FIG. 30 is a cross sectional view taken along line 30-30 of FIG. 28, but showing the top skin member in place; and

FIG. 31 is a cross sectional view taken along line 31-31 of FIG. 28 and additionally showing a thermal barrier between a strut and the bottom skin member, and showing the top skin member in place.

### DETAILED DESCRIPTION

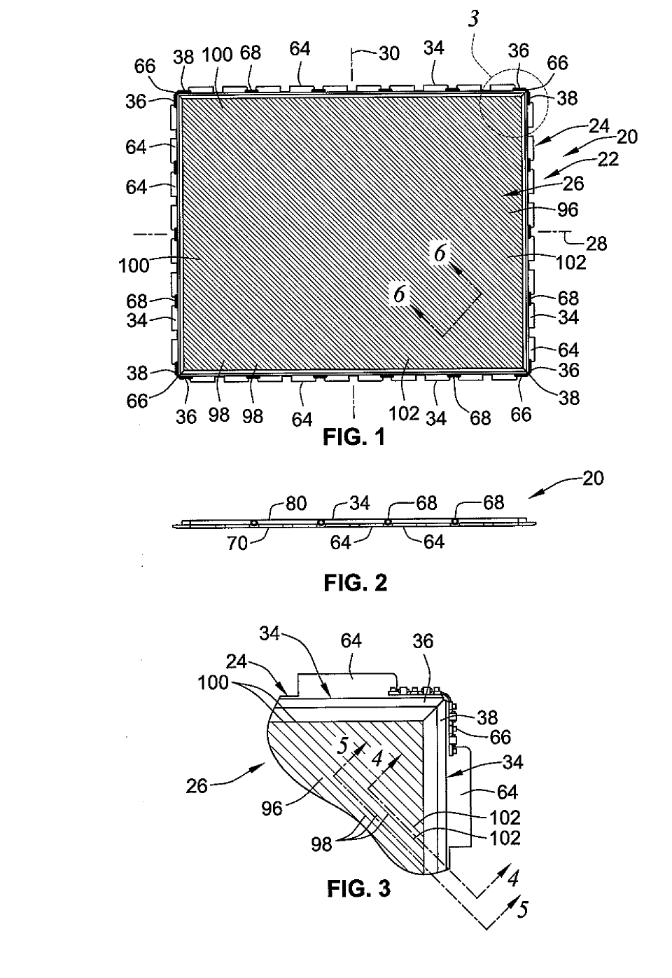

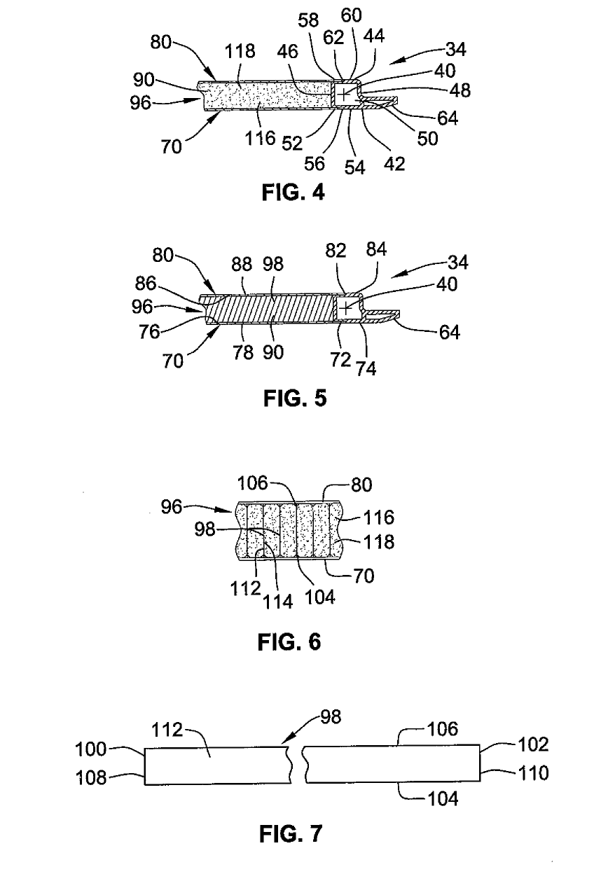

An aircraft cargo pallet 20 is shown in FIGS. 1 and 2. The aircraft cargo pallet 20 comprises a panel 22 including a peripheral frame assembly 24 that extends around a base member 26. Panel 22 as shown in FIG. 1 is generally rectangular and planar. Panel 22 may be formed in other shapes and with various height, width and length dimensions as desired. Panel 22 includes a generally linear central longitudinal axis 28 and a generally linear central transverse axis 30 that is perpendicular to longitudinal axis 28.

Frame assembly 24 of panel 22 includes one or more frame members 34. Panel 22 as shown in FIG. 1 includes four frame members 34 attached end to end in a generally rectangular configuration with two opposing end frame members 34 extending transversely to longitudinal axis 28 and two opposing side frame members 34 extending transversely to transverse axis 30. Frame members 34 may be attached to one another to form a frame assembly in various different configurations as desired.

Each frame member 34 extends between a first end 36 and a second end 38 along a generally linear central axis 40. Each frame member 34 includes a generally planar bottom wall 42 and a generally planar top wall 44 that is spaced apart from and generally parallel to bottom wall 42. Bottom and top walls 42 and 44 extend from first end 36 to second end 38 of frame member 34. Each frame member 34 also includes a generally planar inner wall 46 that extends between inner edges of bottom wall 42 and top wall 44 and between first end 36 and second end 38. Each frame member 34 also includes a generally planar outer wall 48 extending downwardly from an outer edge of top wall 46 toward bottom wall 42. Outer wall 48 is spaced apart from and generally parallel to inner wall 46 and extends between first end 36 and second end 38. Inner wall 46 and outer wall 48 are generally perpendicular to bottom wall 42 and top wall 44. Each frame member 34 includes an elongate hollow chamber 50 formed by bottom wall 42, top wall 44, inner wall 46 and outer wall 48. Bottom wall 42 may include an outer generally planar recessed surface 52 extending outwardly from inner wall 46 to a perpendicular lip 54. Surface 52 and lip 54 form a recess 56. Top wall 44 may include an outer generally planar recessed surface 58 extending outwardly from inner wall 46 to a perpendicular lip 60. Surface 58 and lip 60 form a recess 62. Each frame member 34 also includes a plurality of tabs 64 that are spaced apart from one another and that extend along the length of frame member 34. Each tab 64 extends outwardly from outer wall 48 and bottom wall 44. Tabs 64 are adapted to cooperate with aircraft cargo handling equipment for positioning and securing pallet 20 within an aircraft.

Each of the walls 42, 44, 46 and 48 of frame member 34 may be integrally attached to one another, and each frame member 34 may be formed as an extrusion. Frame member 34 may be formed from a metal, such as aluminum, or from a reinforced composite material. First end 36 of a first frame member 34 is connected to a second end 38 of a second frame member 34 by a bracket 66. Bracket 66 may be coupled to frame members 34 in various manners, such as for example with fasteners such as rivets or by welding. One or more tie downs 68 may be attached to outer wall 48 of each frame member 34 for use in securing cargo to pallet 20.

Base member 26 of panel 22 includes a generally planar first or bottom skin member 70. Bottom skin member 70 extends between a left end and a right end, and between a bottom end and a top end. Bottom skin member 70 is generally rectangular for use with a rectangular frame assembly 24. Each end of bottom skin member 70 includes a generally linear edge 72. Bottom skin member 70 includes a plurality of linear edges 72 that form a rectangular peripheral edge 74 which extends around the perimeter of bottom skin member 70. Bottom skin member 70 includes a generally planar inner surface 76, and a generally planar outer surface 78 that is generally parallel to and spaced apart from inner surface 76. Each edge 72 of bottom skin member 70 is configured to be received in a recess 56 of frame members 34 adjacent lip 54 with inner surface 76 located adjacent recessed surface 52. Each linear edge 72 of bottom skin member 70 may optionally be coupled to frame member 34, such as by adhesive bonding or welding, such as friction stir welding. Bottom skin member 70 may have a thickness between inner surface 76 and outer surface 78 that is approximately equal to the depth of the recess 56 of frame member 34. Bottom skin member 70 may be formed as a relatively thin plate or sheet of material having a thickness of, for example, approximately 0.080 inch. Bottom skin member 70 may be formed from metal, such as aluminum, or from a reinforced composite material.

Base member 26 also includes a second or top skin member 80 that is constructed in generally the same manner as bottom skin member 70. Top skin member 80 is generally planar and extends between a left end and a right end, and between a bottom end and a top end. Top skin member 80 is generally rectangular for use with a generally rectangular frame assembly 24. Each end of top skin member 80 includes a generally linear edge 82. Top skin member 80 includes a rectangular peripheral edge 84, formed by the linear edges 82, that extends around the perimeter of top skin member 80. Top skin member 80 includes a generally planar inner surface 86 and a generally planar outer surface 88 located generally parallel to and spaced apart from inner surface 86. Top skin member 80 may be formed from a relatively thin sheet or plate of material having a thickness of, for example, approximately 0.080 inch, and may be formed from a metal, such as aluminum, or from a reinforced composite material. Each edge 82 of top skin member 80 is configured to be received within a recess 62 of the frame member 34 adjacent lip 60 and adjacent recessed surface 58. Each edge 82 of top skin member 80 is optionally coupled to frame member 34, such as by adhesive bonding or welding, such as friction stir welding. Top skin member 80 is spaced apart from and generally parallel to bottom skin member 70. A chamber 90 is formed between bottom skin member 70 and top skin member 80.

Base member 26 of panel 22 also includes a core 96 located within chamber 90. Core 96 extends between inner surface 76 of bottom skin member 70 and inner surface 86 of top skin member 80, between end frame members 34, and between side frame members 34. As shown in FIG. 1, core 96 includes a plurality of generally linear and elongate ribs 98 that are generally uniformly spaced apart from and parallel to one another. Each rib 98 extends between a first end 100 and a second end 102. Each rib 98 includes a generally linear and continuous bottom edge 104 and a generally linear and continuous top edge 106 that is spaced apart from and generally parallel to bottom edge 104. Each rib 98 includes a generally linear left edge 108 at first end 100 that extends between bottom edge 104 and top edge 106 generally perpendicular thereto. Each rib 98 also includes a generally linear right edge 110 that extends between bottom edge 104 and top edge 106 generally perpendicular thereto. Left edge 108 and right edge 110 are generally parallel to one another. Each rib 98 also includes a generally planar first surface 112 and a generally planar second surface 114 that extend between bottom edge 104 and top edge 106 and between left edge 108 and right edge 110, and that are spaced apart from and generally parallel to one another. Each rib 98 may include a generally planar web extending between bottom edge 104 and top edge 106, one or more bottom tabs extending outwardly from bottom edge 104 generally perpendicular to the web, and one or more top tabs extending outwardly from top edge 106 generally perpendicular to the web. The bottom tabs are adapted to be coupled to bottom skin member 70 and the top tabs are adapted to be coupled to top skin member 80. The bottom and top tabs may extend from the web in the same direction, such that the rib is generally C-shaped, or in opposite directions such that the rib is generally Z-shaped. The tabs provide additional surface area for coupling the rib to bottom skin member 70 and top skin member 80.

As shown in FIG. 6, bottom edge 104 of each rib 98 is coupled to inner surface 76 of bottom skin member 70, and top edge 106 of each rib 98 is coupled to inner surface 86 of top skin member 80. Bottom and top edges 104 and 106 of ribs 98 may be continuously coupled or intermittently coupled to inner surfaces 76 and 86 of skin members 70 and 80 along the length of ribs 98. Bottom and top edges 104 and 106 of rib 98 may be coupled to inner surfaces 76 and 86 of skin members 70 and 80 by welding, such as friction stir welding, or by adhesive bonding. As shown in FIG. 1, ribs 98 extend generally parallel to one another diagonally at an angle to longitudinal axis 28 of panel 22, such as at an angle of approximately forty-five degrees. This angle may be varied such as between approximately twenty degrees and approximately seventy degrees. First end 100 of each rib 98 is located adjacent inner wall 46 of a first frame member 34 and second end 102 is located adjacent inner wall 46 of an adjacent second frame member 34. First end 100 of each rib 98 may optionally be coupled to a frame member 34 and second end 102 may optionally be coupled to a frame member 34, such as by welding, such as friction stir welding, or adhesive bonding.

A chamber 116 is formed between each adjacent pair of ribs 98. Each chamber 116 may be hollow or, if desired, may be filled with a filler 118. Filler 118 may be formed from a foam material or as a plastic shell member. Filler 118 may be used in chambers 116 to inhibit fluid, such as water, from entering into chamber 116, such as if bottom or top skin members 70 or 80 should become punctured. Filler 118 may also be used in chambers 116 to provide additional strength to panel 22. Filler 118 may comprise, for example, a thermoset or thermoplastic material, a thermoplastic honeycomb material, or wood such as balsa wood. The density of the foam material may be varied as desired to adjust the strength of filler 118 and the total weight of filler 118. Filler 118 substantially fills each chamber 116. Filler 118 may optionally be coupled to first surface 112 of a first rib 98 and second surface 114 of an adjacent second rib 98, such as by adhesive bonding.

Each rib 98 may be formed from a metal, such as aluminum, or from a reinforced composite material. Ribs 98 may be spaced apart from one another on centers of approximately 0.587 inch, or at other distances as desired. Each rib 98 may have a thickness between first surface 112 and second surface 114 of approximately 0.025 inch, or another thickness as the application for panel 122 requires. Each rib 98 may have a height between bottom edge 104 and top edge 106 of approximately 2.07 inch, or other heights as desired. Ribs 98 may be spaced apart from one another at a distance that is shorter than the height of ribs 98.

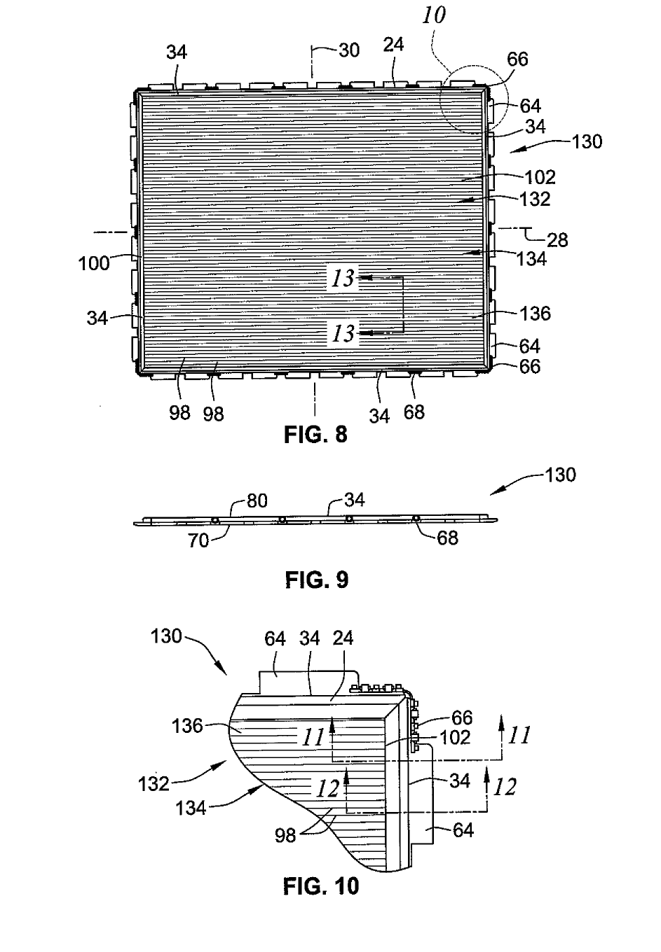

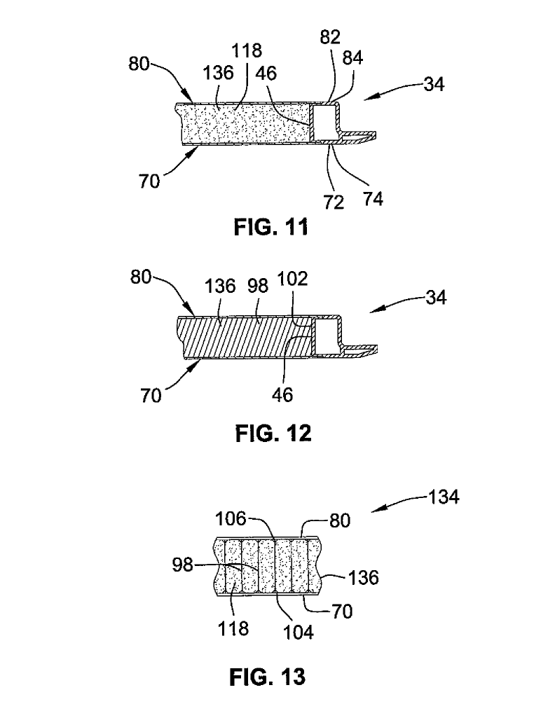

FIGS. 8-13 show an alternate embodiment of the aircraft cargo pallet identified with reference number 130. Pallet 130 contains many of the same components that are constructed and function in the same manner as components in pallet 20. Such components are identified with the same reference number in connection with pallet 130. Pallet 130 comprises a generally planar and rectangular panel 132. Panel 132 includes a generally rectangular frame assembly 24 including a plurality of frame members 34. Panel 132 also includes a generally rectangular and planar base member 134. Base member 134 includes a generally planar bottom skin member 70 and a spaced apart and generally parallel top skin member 80. Base member 134 also includes a core 136 located between bottom skin member 70 and top skin member 80.

Core 136 includes a plurality of generally uniformly spaced apart and generally parallel ribs 98. Ribs 98 of base member 134 extend generally parallel to longitudinal axis 28. First end 100 of each rib 98 is located adjacent an inner wall 46 of an end frame member 34 and second end 102 is located adjacent an inner wall 46 of opposing end frame member 34. Pallet 130 is constructed in substantially the same manner as pallet 20, other than that ribs 98 in panel 132 extend generally parallel to longitudinal axis 28 while ribs 98 in panel 22 extend diagonally with respect to longitudinal axis 28. Alternatively, ribs 98 of base member 134 may extend generally parallel to transverse axis 30 instead of parallel to longitudinal axis 28.

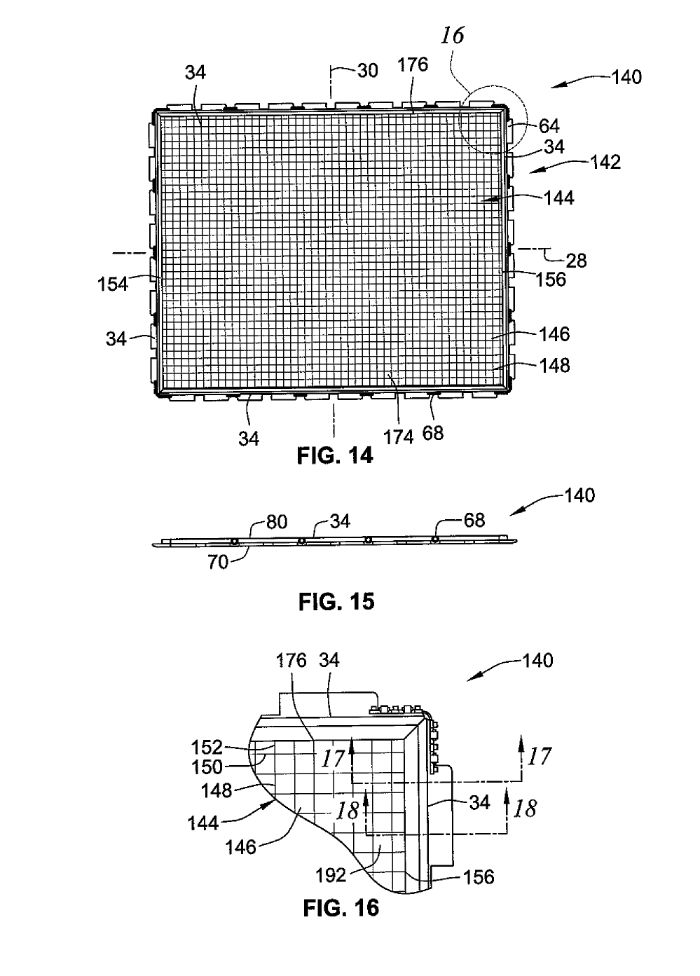

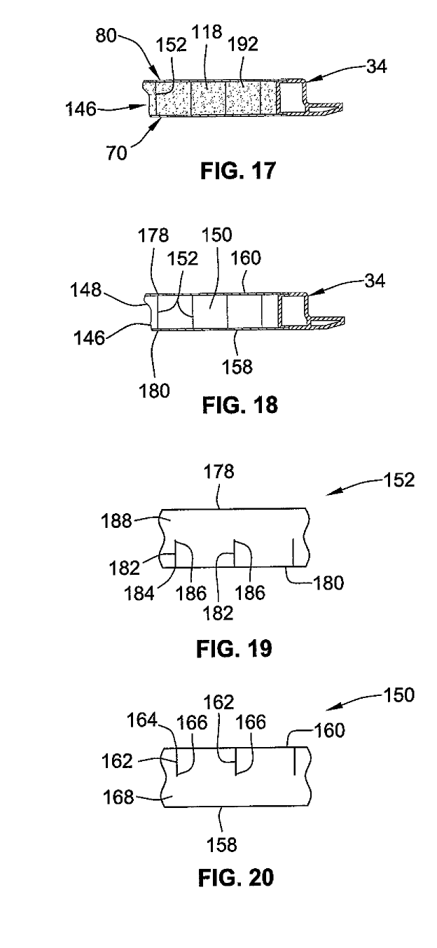

A further embodiment of the aircraft cargo pallet is shown in FIGS. 14-20 and is identified with reference number 140. Pallet 140 includes many of the same components as pallet 20 and such components are identified with the same reference number. Pallet 140 includes a generally rectangular and planar panel 142 including a base member 144 and a frame assembly 24 that extends around base member 144. Base member 144 includes bottom skin member 70 and a spaced apart and generally parallel top skin member 80. Base member 144 includes a core 146 located between bottom skin member 70 and top skin member 80.

Core 146 includes a generally rectangular grid 148 of interlocking transversely arranged ribs. Grid 148 includes a plurality of generally uniformly spaced apart and generally parallel bottom ribs 150 that extend generally parallel to longitudinal axis 28 between opposing end frame members 34. Grid 148 also includes a plurality of generally uniformly spaced apart and generally parallel top ribs 152 that extend generally parallel to transverse axis 30 and at a right angle to bottom ribs 150 between opposing side frame members 34. The direction the bottom ribs 150 and top ribs 152 extend with respect to the frame members 34 may be rotated ninety degrees if desired. Alternatively, grid 148 may be orientated such that bottom ribs 150 and top ribs 152 extend at a diagonal angle with respect to longitudinal axis 28, such as at an angle of approximately forty-five degrees, or at an angle between approximately twenty degrees and approximately seventy degrees.

Each bottom rib 150 extends between a first end 154 and a second 156. Each bottom rib 150 also includes a generally linear and continuous bottom edge 158 that extends between first end 154 and second end 156, and a generally linear notched top edge 160 that extends from first end 154 to second end 156. Each bottom rib 150 includes a plurality of generally uniformly spaced apart and generally parallel slots 162 that extend downwardly from notched top edge 160 toward bottom edge 158. Slots 162 may be spaced apart a distance such as approximately two inches, or other spacings as desired. Each slot 162 extends from an open end 164 at notched top edge 160 to a closed end 166 located approximately midway between bottom edge 158 and notched top edge 160. A web 168 extends between bottom edge 158 and closed end 166 of each slot 162. Each slot 162 includes spaced apart and generally parallel side edges that extend from notched top edge 160 to closed end 166.

Each top rib 152 extends between a first end 174 and a second end 176. Each top rib 152 includes an elongate generally linear and continuous top edge 178. Each top rib 152 also includes an elongate and generally linear notched bottom edge 180. Top edge 178 and notched bottom edge 180 extend between first end 174 and second end 176. Each top rib 152 includes a plurality of generally uniformly spaced apart and generally parallel linear slots 182. Slots 182 may be spaced apart a distance such as approximately two inches, or other spacings as desired. The spacing of slots 182 may be approximately equal to the spacing of slots 162. Each slot 182 includes an open end 184 at notched bottom edge 180 that extends toward top edge 178 to a closed end 186. Closed end 186 is located approximately midway between top edge 178 and notched bottom edge 180. A web 188 extends between top edge 178 and closed end 186 of each slot 182. Top rib 152 is constructed substantially identical to bottom rib 150 other than that top rib 152 is inverted with respect to bottom rib 150. Bottom ribs 150 and top ribs 152 may be formed from metal, such as aluminum, or from a reinforced composite material.

Bottom edges 158 of bottom ribs 150 and notched bottom edges 180 of top ribs 152 are located adjacent to and are coupled to inner surface 76 of bottom skin member 70, such as by adhesive bonding or welding, such as friction stir welding. Top ribs 152 are located transversely to bottom ribs 150 and are interlocked with bottom ribs 150 such that a web 168 of each bottom rib 150 is located within a slot 182 of a top rib 152, and such that a web 188 of each top rib 152 is located within a slot 162 of a bottom rib 150. Bottom ribs 150 and top ribs 152 are thereby interlocked with one another. Bottom ribs 150 and top ribs 152 may be coupled to one another by adhesive bonding or welding, such as friction stir welding, along slots 162 and 182 such that webs 168 are coupled to top ribs 152 and webs 188 are coupled to bottom ribs 150. Notched top edges 160 of bottom ribs 150 and top edges 178 of top ribs 152 may be coupled to inner surface 86 of top skin member 80 by adhesive bonding or welding, such as friction stir welding. Grid 148 includes a plurality of hollow chambers 192 formed between adjacent bottom ribs 150 and adjacent top ribs 152 and between bottom skin member 70 and top skin member 80. Each chamber 192 may be filled with a filler 118 if desired.

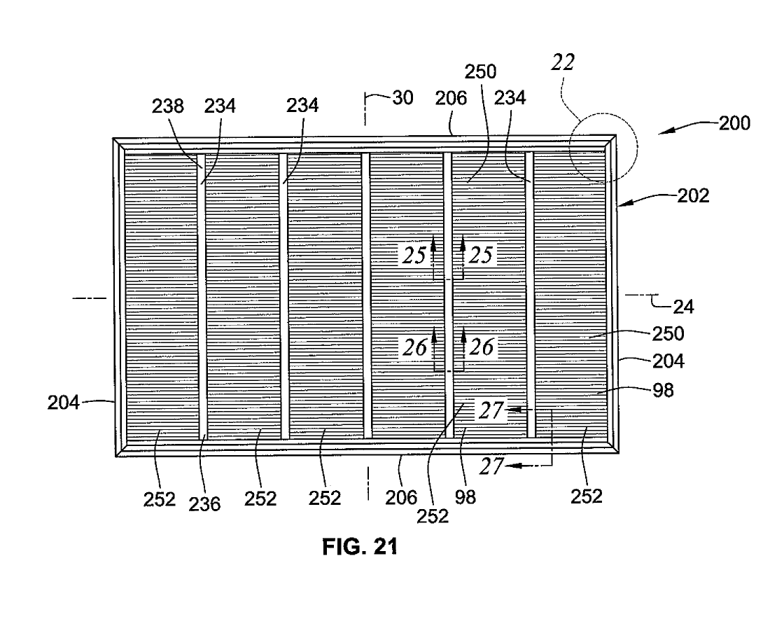

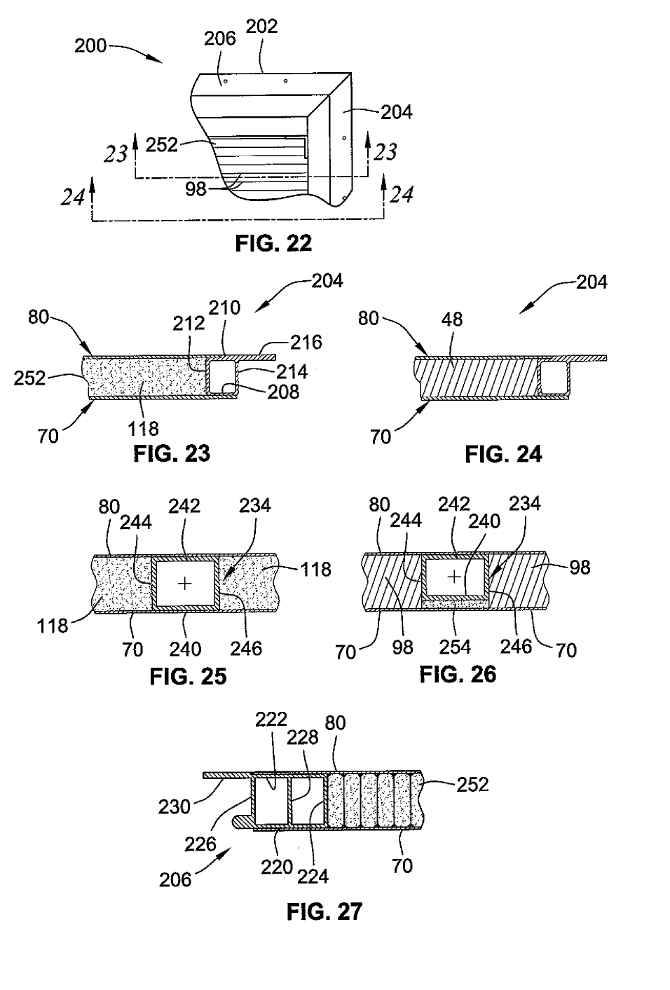

A further embodiment of a panel is shown in FIGS. 21-27 and is identified with reference number 200. Panel 200 includes components that are constructed in the same manner as components of panel 132 and such components are numbered with the same reference number. Panel 200 includes a frame assembly 202. Frame assembly 202 includes a pair of spaced apart and generally parallel elongate end frame members 204 and a pair of spaced apart and generally parallel elongate side frame members 206. Side frame members 206 extend generally perpendicular to end frame members 204 and between respective ends of end frame members 204. Each end frame member 204 includes a generally planar bottom wall 208, a generally planar top wall 210, a generally planar inner wall 212 and a generally planar outer wall 214 in the form of a generally rectangular hollow tube. Top wall 210 may include a recessed surface and a lip forming a recess as does top wall 44 of frame member 34. Each frame member 204 includes a generally planar plate-like flange 216 that extends outwardly from outer wall 214 generally parallel with top wall 210.

Each side frame member 206 includes a generally planar bottom wall 220, a generally planar top wall 222, a generally planar inner wall 224 and a generally planar outer wall 226 in the general form of a rectangular hollow tube. Top wall 222 may include a recessed surface and a lip forming a recess as does top wall 44 of frame member 34. A center wall 228 extends between top wall 222 and inner wall 224 generally midway between the inner wall 224 and outer wall 220. A generally planar plate-like flange 230 extends outwardly from outer wall 226 generally parallel to top wall 222. Frame members 204 and 206 may be formed from metal, such as aluminum, or from a reinforced composite material.

Panel 200 also includes a base member 250 having a plurality of generally linear and elongate struts 234 that are generally uniformly spaced apart from one another and that extend generally parallel to one another and parallel to transverse axis 30. Each strut 234 extends between a first end 236 and a second end 238. First end 236 of each strut 234 is coupled to a first side frame member 206 and second end 238 of each strut 234 is coupled to a second side frame member 206. Each strut 234 includes a bottom wall 240, a spaced apart and generally parallel top wall 242, and a first side wall 244 that is spaced apart from and generally parallel to a second side wall 246. Each of the walls 240, 242, 244 and 246 is generally planar and form a generally rectangular hollow tube. Each strut 234 may be formed from a metal, such as aluminum, or from a reinforced composite material. Base member 250 also includes a bottom skin member 70 and a spaced apart top skin member 80. As shown in FIG. 25, bottom wall 240 of strut 234 may be coupled to bottom skin member 70, and top wall 242 of strut 234 may be coupled to top skin member 80 by adhesive bonding or by welding, such as friction stir welding.

Base member 250 includes a plurality of cores 252 constructed in generally the same manner as the core 136 of panel 132. Each core 252 is located adjacent inner surface 76 of bottom skin member 70 and inner surface 86 of top skin member 80 and extends generally parallel to transverse axis 30 between side frame members 206 and generally parallel to longitudinal axis 24 between adjacent struts 234 or between a strut 234 and an end frame member 204. Ribs 98 of core 252 extend generally parallel to longitudinal axis 24 between adjacent struts 234 and between each end frame member 204 and an adjacent strut 234. Bottom edges 104 of ribs 98 are coupled to bottom skin member 70 and top edges 106 of ribs 98 are coupled to top skin member 80 such as by adhesive bonding or welding, such as friction stir welding. Chambers 116 between ribs 98 may optionally be filled with filler 118 as desired as in connection with panels 22 and 132. First and second ends 100 and 102 of ribs 98 and the ends of filler 118 may optionally be coupled to first and second side walls 244 and 246 of struts 234 and to inner walls 212 of end frame members 204 such as by adhesive bonding, and in the case of the ribs 98 also by welding, such as friction stir welding. Alternatively, ribs 98 of core 252 may extend generally parallel to transverse axis 30 and generally parallel to struts 234. In addition, ribs 98 may alternatively extend diagonally at an angle to longitudinal axis 24 such as at an angle of approximately forty-five degrees, or at an angle between approximately twenty degrees and approximately seventy degrees.

As shown in FIG. 26, if desired, bottom wall 240 of each strut 234 may be spaced apart from inner surface 76 of bottom skin member 70 to form a gap in which a thermal barrier 254 is placed. Thermal barrier 254 may be coupled to bottom wall 240 and bottom skin member 70 by adhesive bonding. Thermal barrier 254 may be formed from a thermally nonconductive material, for example, wood or reinforced composite materials. Thermal barrier 254 extends between first and second side walls 244 and 246 and first end 236 and second end 238 of each strut 234. The edges of bottom skin member 70 may be coupled to bottom walls 208 of end frame members 204 and to bottom walls 220 of side frame members 206 such as by adhesive bonding or welding, such as friction stir welding. The edges of top skin member 80 may be coupled to top wall 210 of end frame members 204 and top walls 222 of side frame members 206 such as by adhesive bonding or welding, such as friction stir welding.

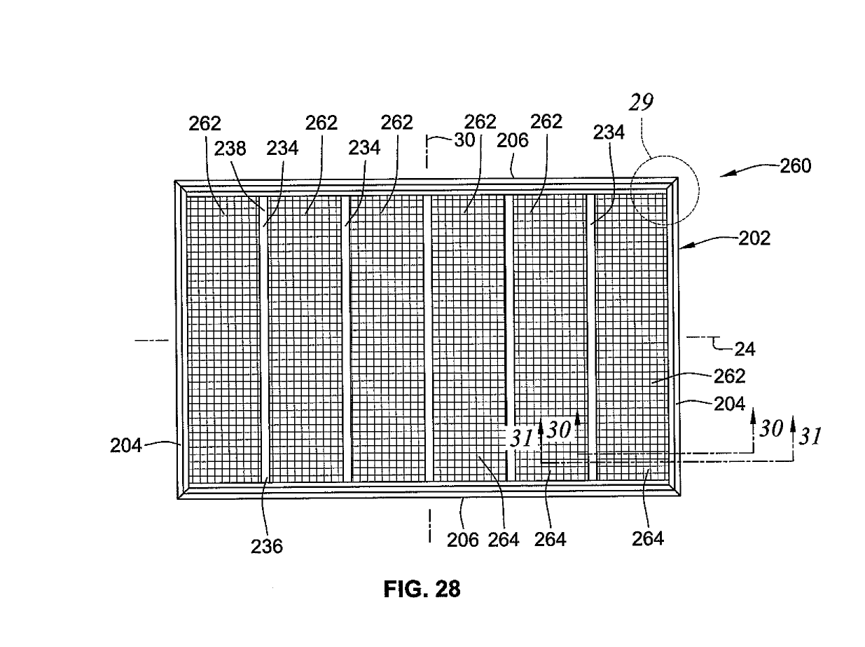

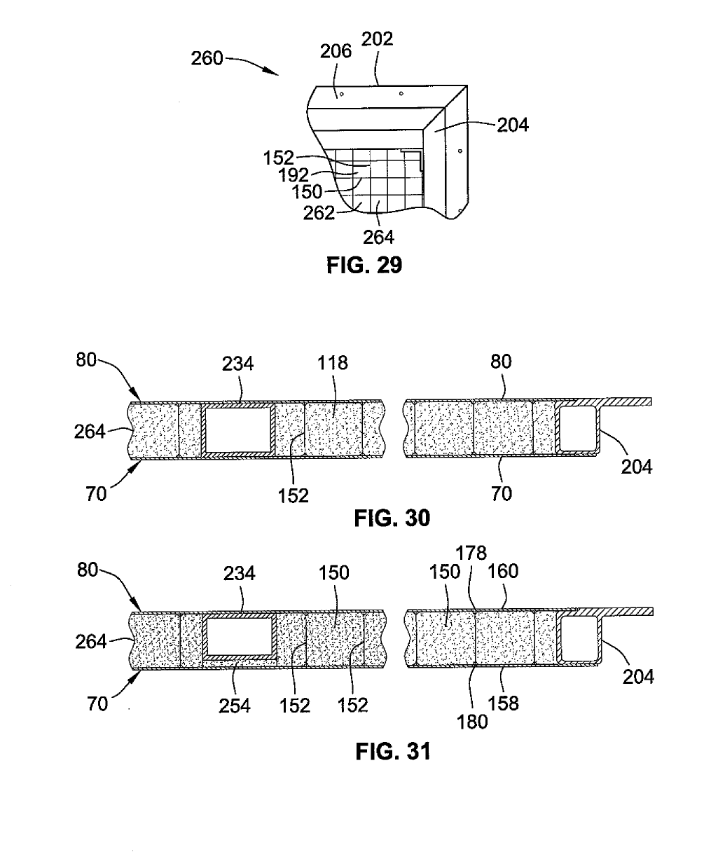

A further embodiment of a panel according to the present disclosure is shown in FIGS. 28-31 and is identified with the reference number 260. Panel 260 includes some of the same components as panel 142 and panel 200 and similar components are identified with the same reference number. Panel 260 includes a frame assembly 202 having end frame members 204 and side frame members 206. Panel 260 also includes a base member 262 having a plurality of struts 234 extending between side frame members 206 as in panel 200, a bottom skin member 70 and a top skin member 80. Base member 262 includes a plurality of cores 264 constructed in the same manner as core 146 of pallet 140 including a generally rectangular grid 148 formed by bottom ribs 150 and top ribs 152 disposed generally at a right angle to bottom ribs 150. Bottom ribs 150 may extend generally parallel to longitudinal axis 24 with top ribs 152 extending generally parallel to transverse axis 30. Alternatively, the direction in which bottom ribs 150 and top ribs 152 extend may be rotated ninety degrees if desired. Additionally, if desired, bottom ribs 150 and top ribs 152 may extend diagonally at an angle to longitudinal axis 24 such as at an angle of approximately forty-five degrees, or at an angle between approximately twenty degrees and approximately seventy degrees.

Each core 264 extends between opposing side frame members 206. Each core 264 also extends between adjacent struts 234 or between a strut 234 and an end frame member 204. Bottom skin member 70 extends between end frame members 204 and side frame members 206. Bottom skin member 70 may be coupled to bottom walls 208 of end frame members 204, bottom walls 220 of side frame members 206, bottom walls 240 of struts 234, bottom edges 158 of bottom ribs 150, and notched bottom edges 180 of top ribs 152 such as by adhesive bonding or welding, such as friction stir welding. Top skin member 80 may be coupled to top walls 210 of end frame members 204, top walls 222 of side frame members 206, top walls 242 of struts 234, notched top edges 160 of bottom ribs 150, and top edges 178 of top ribs 152 such as by adhesive bonding or welding, such as friction stir welding. Bottom ribs 150 and top ribs 152 may optionally be coupled to end frame members 204, side frame members 206 and struts 234 such as by adhesive bonding or welding, such as friction stir welding. As shown in FIG. 31, a thermal barrier 254 may be located between bottom wall 240 of each strut 234 and bottom skin member 70.

The panels disclosed herein may be used to form aircraft cargo pallets and other structures such as the walls or floors of enclosures and containers. The panels and aircraft cargo pallets disclosed herein provide a high strength to weight ratio. The aircraft cargo pallets, and other structures such as enclosures and containers formed by the panels disclosed herein, are particularly suited for transport in an aircraft.

1. A panel for forming a structure, said panel comprising:
a first skin member having an inner surface, an outer surface and a peripheral edge;
a second skin member having an inner surface, an outer surface and a peripheral edge, said second skin member spaced apart from and generally parallel to said first skin member;
one or more cores located between said first skin member and said second skin member, each said core including a plurality of elongate first ribs, said first ribs being spaced apart from one another and generally parallel to one another, each said first rib having an elongate first edge coupled to said inner surface of said first skin member and an elongate second edge coupled to said inner surface of said second skin member.

2. The panel of claim 1 wherein said first ribs have a height between said first edge and said second edge of said first ribs, said first ribs being spaced apart from one another a distance that is shorter than said height of said first ribs.

3. The panel of claim 1 wherein said first rib members are generally spaced apart from one another a distance of approximately 0.587 inch.

4. The panel of claim 1 wherein said first edges of said first ribs are welded to said first skin member.

5. The panel of claim 1 wherein said first edges of said first ribs are friction stir welded to said first skin member.

6. The panel of claim 1 wherein said first edges of said first ribs are adhesively bonded to said first skin member.

7. The panel of claim 1 wherein said first edges of said first ribs are substantially continuously coupled to said first skin member along the length of said first edges.

8. The panel of claim 1 wherein said first ribs extend at an angle between approximately twenty degrees and approximately seventy degrees to a longitudinal axis of said panel.

9. The panel of claim 1 wherein said first skin member and said second skin member are each generally rectangular.

10. The panel of claim 1 including one or more chambers formed between each adjacent pair of first ribs, each said chamber being filled with a filler.

11. The panel of claim 1 wherein said core includes a plurality of elongate second ribs, said second ribs being spaced apart from one another and generally parallel to one another, said second ribs extending generally transversely to said first ribs, each said second rib having an elongate first edge coupled to said inner surface of said first skin member and an elongate second edge coupled to said inner surface of said second skin member.

12. The panel of claim 11 wherein said second ribs are interlocked with said first ribs.

13. The panel of claim 11 wherein each said first rib includes a plurality of spaced apart first slots extending inwardly from said first edge of said first rib and a first web located between each said first slot and said second edge of said first rib, and each said second rib includes a plurality of spaced apart second slots extending inwardly from said second edge of said second rib and a second web located between each said second slot and said first edge of said second rib, said first web of each said first rib being located within one or more of said second slots of said second ribs and said second web of each said second rib being located within one or more of said first slots of said first ribs.

14. The panel of claim 1 including a first side frame member, a second side frame member, a plurality of struts extending between said first side frame member and said second side frame member, said struts being spaced apart and generally parallel to one another, and a core located between each adjacent pair of struts.

15. The panel of claim 14 including one or more thermal barriers, a thermal barrier being located between each said strut and said first skin member, each said strut being coupled to said second skin member.

16. The panel of claim 1 including a plurality of frame members extending around said peripheral edge of said first skin member, each said frame member including a first wall having a first recess adapted to receive said first skin member and a second wall having a second recess adapted to receive said second skin member.

17. The panel of claim 16 wherein each said frame member includes a plurality of outwardly extending tabs adapted to cooperate with aircraft cargo handling equipment.

18. The panel of claim 1 wherein each said first rib includes a web extending between said first edge and said second edge, one or more first tabs extending outwardly from said first edge and one or more second tabs extending outwardly from said second edge, said first tabs adapted to be coupled to said first skin member and said second tabs adapted to be coupled to said second skin member.

19. A method of forming a panel comprising the steps of:
providing a plurality of elongate first ribs spaced apart and generally parallel to one another, each said first rib including an elongate first edge and an elongate second edge;
placing a first skin member having an inner surface, an outer surface and a peripheral edge, adjacent said first ribs with said inner surface of said first skin member adjacent said first edges of said first ribs;
coupling said first edges of said first rib members to said first skin member; and
placing a second skin member having an inner surface, an outer surface and a peripheral edge, adjacent said first ribs with said inner surface of said second skin member located adjacent said second edges of said first ribs.

20. The method of claim 19 wherein said first edge of said first ribs are coupled to said first skin member by welding.

21. The method of claim 19 wherein said first edges of said first ribs are coupled to said first skin member by friction stir welding or adhesive bonding.

22. The method of claim 19 including interlocking a plurality of second ribs with said first ribs, and coupling said second ribs to said first skin member.

23. The method of claim 19 including filling chambers formed between adjacent pairs of said first ribs with a filler.
